(19) United States
(12) Patent Application Publication
(10) Pub. No.: US 2021/0033637 A1
(43) Pub. Date: Feb. 4, 2021

(54) Situational Awareness Trainer

(71) Applicant: Rudy Moore, MADISON, WI (US)

(72) Inventor: Rudy Moore, MADISON, WI (US)

(21) Appl. No.: 16/902,259

(22) Filed: Jun. 15, 2020

Related U.S. Application Data
(63) Continuation-in-part of application No. 62/862,020, filed on Jun. 15, 2019.

(51) Int. Cl. G01P 5/00; G08G 5/00; G09B 19/16; B64D 45/00

(52) U.S. Cl. CPC G01P 5/00; G08G 5/003; B64D 2045/0075; B64D 45/00; G09B 19/167

(57) ABSTRACT

This disclosure relates to methods and devices for detecting configurations of aircraft. A sound is recorded from an interior of an aircraft. A transform is calculated of the sound. The transform is compared with a calibration transform of a known configuration. A closeness parameter is determined based on the comparison. A detected configuration is indicated if the closeness parameter is above a threshold.

### CROSS-REFERENCE TO RELATED PATENT APPLICATIONS

The present application is a continuation-in-part of U.S. Provisional Application No. 62/862,020, filed Jun. 15, 2019, the entire disclosure of which is incorporated herein by reference.

### BACKGROUND

Embodiments of the present application relate to the field of education and the field of instrumentation. More specifically, representative embodiments relate to methods and systems for detecting performance characteristics of an operating machinery, such as but not limited to, an aircraft, an automobile, manufacturing equipment, power tools, or other device that creates sounds as a byproduct of operating. Other representative embodiments relate to user interaction and control of the operating machinery where detection by the user of situational parameters effects the user's ability to control the operating machinery.

### SUMMARY

This disclosure is directed to a method, device and system for efficiently detecting airspeed.

An illustrative method of detecting a configuration of an aircraft is disclosed. A sound is recorded from an interior of an aircraft. A transform is calculated of the sound. The transform is compared with a calibration transform of a known configuration. A closeness parameter is determined based on the comparison. A detected configuration is indicated if the closeness parameter is above a threshold.

In alternative embodiments of the method, the transform of the sound is a Fourier Transform. In another embodiment of the method, the transform of the sound is a wavelet transform. In another embodiment of the method, the transform is a time-frequency transform. In another embodiment of the method, the transform of the sound is normalized before comparison with the first calibration transform. In alternative embodiments of the method, a factor used to normalize the transform is used to scale the detected configuration.

In alternative embodiments of the method, the first configuration is a first airspeed and the detected configuration is a detected airspeed. In another embodiment of the method, comparing the transform includes calculating a dot-product of the transform with the first calibration transform. In another embodiment of the method, a continuous moving average is used to smooth out the first closeness parameter.

Another illustrative method of detecting an airspeed of an aircraft is disclosed. A sound is recorded from an interior of an aircraft. A transform is calculated of the sound. The transform is compared with a first calibration transform of a known configuration. A first closeness parameter is determined based on the comparison. The transform is compared with a second calibration transform of a second configuration. A second closeness parameter is determined based on the comparison. A detected configuration is selected from between the first configuration and the second configuration based on the first closeness parameter and the second closeness parameter. The detected configuration is indicated to the user.

In alternative embodiments of the method, comparison of the transform includes identifying a difference in an analogous region between the first calibration transform and the second calibration transform and then comparing the analogous region of the transform with the analogous region of the first calibration transform and the second calibration transform.

In alternative embodiments of the method, selection of a detected configuration is based on a supervised machine learning.

### BRIEF DESCRIPTION OF THE DRAWINGS

FIG. 1 is an illustration of a block diagram for a flight coach training device.

FIG. 2 is a diagram illustrating a simplified system for detecting an airspeed.

FIG. 3 is a diagram illustrating a simplified system for detecting uncoordinated flight.

FIG. 4 is a diagram illustrating how multiple sensors can be combined to form a larger picture of machine operation.

FIG. 5 is a diagram depicting how samples used by the comparators of FIG. 2 and FIG. 4 and the implicit comparator of the process depicted in FIG. 3 can be created.

FIG. 6 is a diagram depicting a sample user interface that allows a pilot to both be notified of specific flight regimes and to also notify the device that a flight regime will be intentionally entered.

FIG. 7 is a diagram depicting a sample user interface that allows a user to compare their results against other users of the device.

FIG. 8 is a diagram depicting a block diagram of another embodiment of a pilot training tool.

### DETAILED DESCRIPTION

Illustrative embodiments are presented within a framework of an aviator educational aid. The device is one embodiment which has the specific aim of teaching pilots to better recognize the sound of slow flight and the feeling of uncoordinated flight through repeated guided recognition of underlying physical characteristics of flight.

Many types of maneuvers in aviation are used in normal operations yet are errors when performed unintentionally. For example, and without limitation, a stall is used in order to land the aircraft and an uncoordinated slip is used to keep the plane aligned with a runway in a crosswind. Other flight conditions, without limitation, can include over-speed flight, high-G maneuvers, high or low engine temperature situations, flight with unusual weight and balance conditions including misloaded aircraft, and low-fuel situations. When inadvertent, the maneuvers as errors can lead to loss of control of the aircraft when they exceed the ability of the pilots that perform them or the design capabilities of the aircraft. Flight instruction in primary flight training spends time on recognizing these situations and learning how to correct them. Yet, there are multiple factors that lead to pilots becoming unaware that they are even in the erroneous flight condition. The fact that many of these maneuvers may be used with intentionality trains the senses to become less alarmed by the physical characteristics that indicate the airplane is in a particular flight regime. Through repetition, the pilot becomes less aware of them. Similarly, because the early stages of the maneuvers are easy to correct for, there can be a higher tolerance and even nonchalance about entering these flight regimes.

There are instruments and alert systems designed to notify a pilot of their approach to the edges of the flight envelope. For example, an airspeed indicator has colored markings on it that show stall speeds and over-speed situations. The turn-coordinator includes a ball that shows uncoordinated flight. And some instrumentation is specifically designed to act as an alarm like the stall horn in many light aircraft. Yet, accidents still happen because pilots fail to check the instruments, fail to recognize what the instruments are showing, or fail to respond to the cues these instruments provide. To solve this problem, pilots need better skills at recognizing the situation before it becomes a problem so that they can provide the appropriate correction.

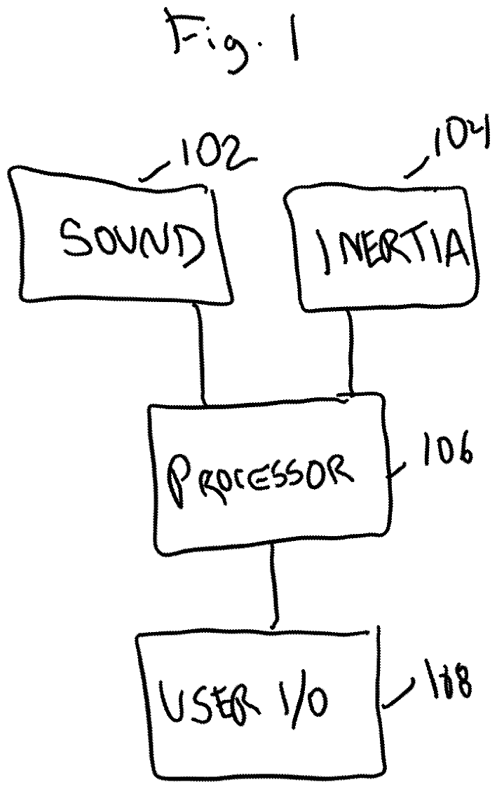

FIG. 1 is an illustration of a block diagram for a flight coach training device. The device comprises a sound detection component 102, an inertial measurement unit 104, a processor block 106, and user interface components 108. Ambient sounds are detected in the sound detection component 102. Acceleration and orientation are determined in the inertial measurement unit 104. The design allows for greater or fewer instrumentation blocks. Processor block 106 records from the sound detection component 102 and the inertial measurement unit 104, analyzes those inputs, presents data, and receives input from the user interface components 108.

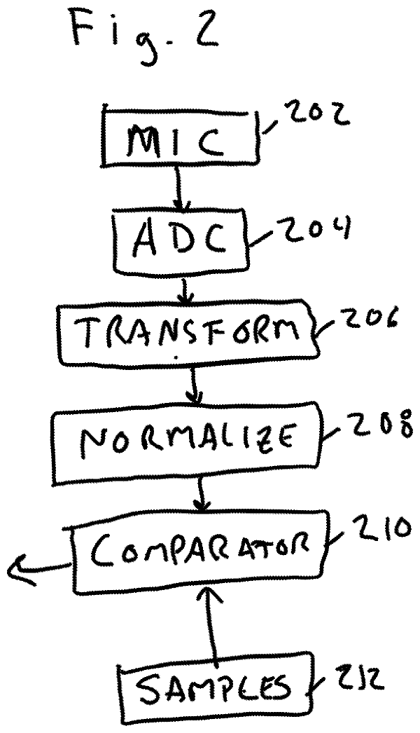

FIG. 2 is a diagram illustrating a simplified system for detecting an airspeed or other sound based criteria to be detected. An incident sound is detected at a microphone circuit 202 and digitized in an analog-to-digital converter 204 to record the sound. The sound is transformed by converting to a frequency domain representation in a transform 206. The transform could be a fast Fourier Transform, a wavelet transform, or many other transform methods. The frequency domain representation contains information about both the frequency and amplitude of incident sounds. In alternative transforms, time-frequency representation (TFR) may be analyzed with time-frequency transform such as, but not limited to, a bilinear TFR, a quadratic TFR, spectrogram, scaleogram, or other wavelet transforms. Analysis may be simplified by normalizing the frequency domain representation in a normalize 208. The energy level of the frequency domain representation may be preserved by tracking the factors necessary to normalize the frequency domain representation. The normalized frequency domain representation may then be compared in comparator 210 against multiple calibration representation samples 212. One method of comparison is to take the dot product of the transform (e.g. a normalized frequency domain representation) with each of the calibration representations individually. Another method is to compare calibration representations with each other to discern differences created by particular flight regimes. Transforms of samples (e.g. Frequency domain representations of the samples) may then be compared against these specific differences in order to determine how closely the sample matches those calibration representations. Other methods can include pattern recognition, discriminant analysis, or supervised or unsupervised machine learning. The magnitude of each dot product indicates how close the incident sound is to the calibration representations. When a calibration representation is selected that corresponds to an airspeed, then the magnitude of the dot product indicates closeness or most-likely match to the airspeed in question. A threshold can be used to determine whether the closeness calculation is sufficiently close to be a likely match of the airspeed in question. A continuous moving average or similar algorithm may be used to smooth out the closeness calculations.

When the energy level of the frequency domain representation is preserved as described above, the energy level may be used to provide a scaling factor in subsequent calculations to narrow in on any error factor between the detected airspeed and a true airspeed of the aircraft.

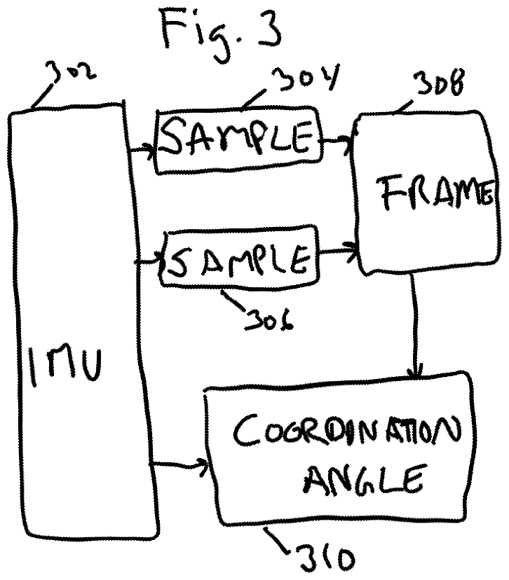

FIG. 3 is a diagram illustrating a simplified system for detecting uncoordinated flight. An inertial measurement unit 302 provides data such as specific forces, angular rates, and orientation of the aircraft. At sample 304, a sample of accelerometer data is taken while the aircraft is at rest on the ground to determine a vector due to gravity. At sample 306, a sample of accelerometer data is taken in a known configuration, in one case during coordinated slow flight, in order to detect the change in the pitch axis. With a vector due to gravity and a vector due to a known change in pitch, the pitch axis, the roll axis, and the yaw axis can all be determined at frame calculation 308. The pitch axis is just the normalized cross product between the vector due to gravity and the change in the pitch axis. The roll axis is just the normalized cross product between the pitch axis and the vector due to gravity. And the yaw axis is just the normalized cross product between the pitch axis and the roll axis. With frame calculation 308 and further samples from the inertial measurement unit 302, coordination angle 310 can be calculated. The coordination angle 310 is the inverse cosine of the dot product of the inertial measurement unit 302 acceleration vector against the pitch axis determined in the frame calculation 308.

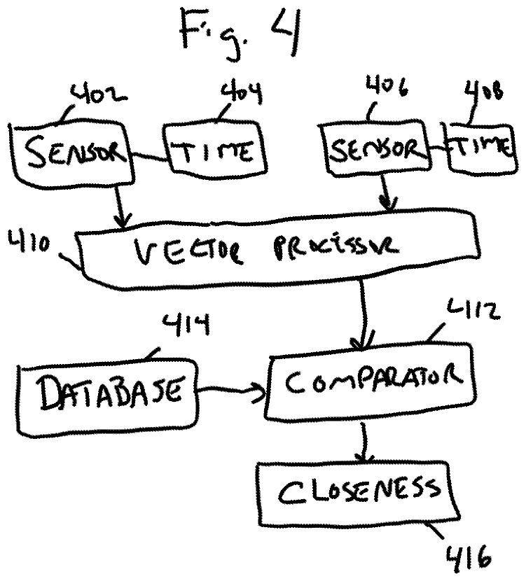

FIG. 4 is a diagram illustrating how multiple sensors can be combined to form a larger picture of machine operation. For example, in aviation a spin may occur when a plane is stalled in an uncoordinated manner. These two states are measured in different systems and must be combined. While the extremes are easy to detect using just the instrumentation already presented, a more nuanced picture can be developed by analyzing the detected data together. Sensor 402 is tagged with time information 404. Sensor 406 is tagged with time information 408. The tagged sensor information is combined in vector processor 410. Comparator 412 compares vector processor 410 output with samples stored in database 414. A closeness 416 is output which indicates how close the detected situation is to the stored samples. The same approach can be adapted and generalized to detect any condition characterized by the type of sensors available.

Though we have presented cases where heightened awareness is needed by the pilot, the individual sensor data of FIG. 2 and FIG. 3 and the combined sensor data of FIG. 4 can be used to detect situations that are simply general conditions of operation of the machinery. In aviation, these might correspond to basic maneuvers like climbs, descents, and turns. Or they can correspond to more complicated maneuvers like a chandelle, a lazy-eight, turns on a point, or steep turns. These maneuvers are detected by selection of samples used by the comparators. A time-sequenced list of the maneuvers can then be built up to create a profile any particular complete operation of the machine. In aviation, this can amount to a procedure-by-procedure summary of the flight. They are also automatically graded by how well they match the sample in terms of closeness. Thus, a database can be formed showing each of these maneuvers and any progression in time as to how well the pilot is performing those maneuvers.

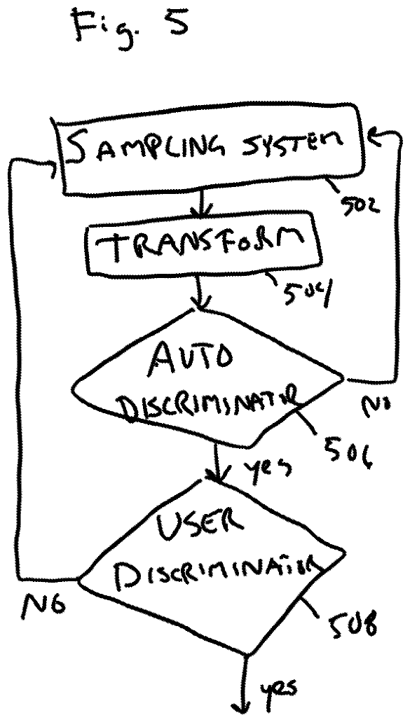

FIG. 5 is a diagram depicting how samples used by the comparators of FIG. 2 and FIG. 4 and the implicit comparator of the process depicted in FIG. 3 can be created. The systems presented above use samples that have been created a priori, such as by an instructor or during a calibration. Sampling system 502 samples the physical phenomena that correspond to the calibration sample using whichever sensors are required for the calibration sample. Transform 504 converts the sample into a usable format. The method that transform 504 employs depends on the type of sample created. Automatic discrimination 506 judges the calibration sample against various criteria including data quality and/or distinguishing characteristics from other calibration samples. When automatic discrimination 506 determines that a sample will not be usable, the system goes back to sampling system 502 to repeat the measurement. User discrimination 508 allows the user to judge whether the calibration sample qualifies for the usage needed.

It is also possible to improve on the detection system by using an automated method of creating further samples. In this method, each sample is categorized by how well it matches an initial sample as measured by the closeness parameter described herein. For candidate samples, the sample is further broken down into components and each component is then compared with matching components of existing samples. When a component is a close match, a weighting factor is created that gives higher weighting to that component in subsequent comparisons. When a component is not a close match, the weighting factor is set to give less weighting to that component. Over time, the system develops a set of weighting factors that more closely characterize the sample detection criteria.

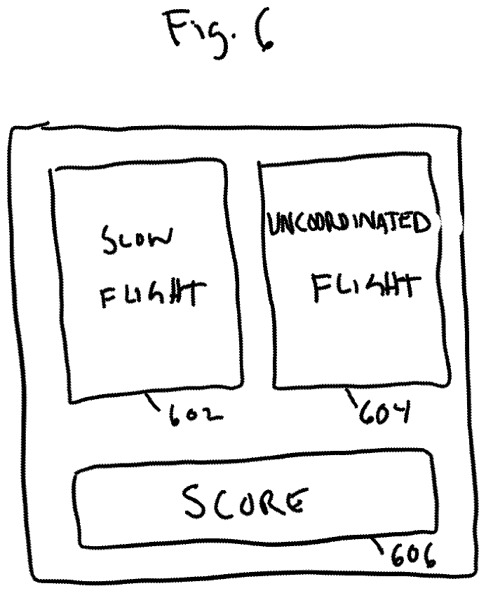

FIG. 6 is a diagram depicting a sample user interface that allows a pilot to both be notified of specific flight regimes and to also notify the device that a flight regime will be intentionally entered. The pilot uses the same interface for both notification and acknowledgment in order to solidify the relationship between the learned environmental characteristics and the flight regime that produces those environmental characteristics. The sample user interface is broken into regions. Slow flight area 602 indicates and receives notifications regarding slow flight. Uncoordinated flight area 604 indicates and receives notifications regarding uncoordinated flight. Both slow flight area 602 and uncoordinated flight area 604 indicate a flight condition by displaying an annunciator or data corresponding to the respective flight regime. Both slow flight area 602 and uncoordinated flight area 604 allow the pilot to acknowledge the flight regime by pressing the respective screen area. Both slow flight area 602 and uncoordinated flight area 604 register a pilot's intention to enter the flight regime with the pilot pressing the screen in that area. A pilot's innate understanding of their flight regime is improved as the pilot gets better at predicting that they will be entering a particular flight regime.

This approach to user interface highlights one fundamental difference between an alert system and a training system. The flight regimes detected may be entered for many reasons sometimes in the course of normal flight and sometimes in the course of training maneuvers. An alert is inherently unidirectional and may eventually be unintentionally ignored by a pilot. An acknowledged alert shows the pilot has observed the flight regime. But an anticipated alert shows the pilot actually understands that an aircraft is about to enter a flight regime. This shows the highest level of flight awareness. Similarly, an alert presented as an alarming situation steers pilots away from entering these flight regimes. However, the flight regimes are useful in ordinary operations of aircraft. For example, every flight ends safely in slow flight. Or a slip may be used to safely position the aircraft in relation to the ground. In these cases, an alert would need to be ignored by a pilot as they continue safe operations. Through repetition over many flights, this has the effect of training the pilot to ignore alerts. However, an anticipation system, through that same repetition, trains the pilots to anticipate the flight characteristics of the aircraft and leads to the highest situational awareness of the measured characteristics of the flight regime.

Score 606 gives the pilot a real-time understanding of how well they are doing at anticipating flight regimes. This has the effect of motivating the pilot to improve. Score 606 is broken down into the number of events anticipated and the number of events missed. Over the course of a flight a pilot can see these numbers rise as the system detects each flight regime.

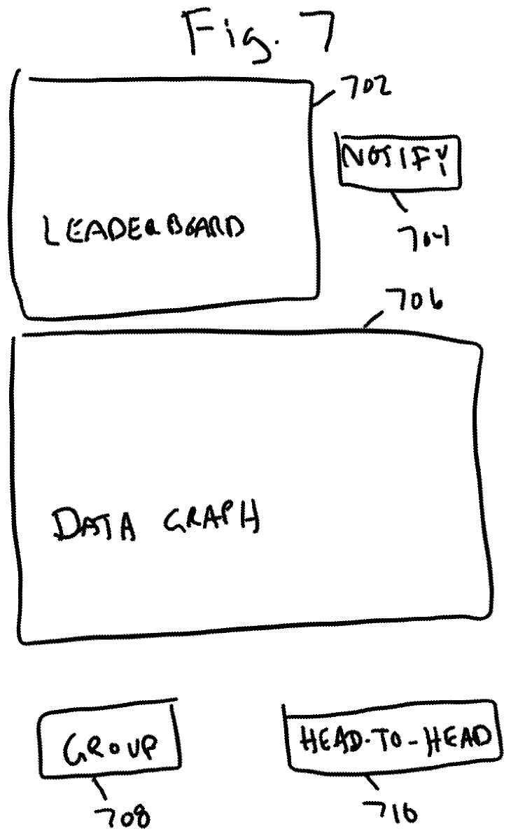

FIG. 7 is a diagram depicting a sample user interface that allows a user to compare their results against other users of the device. Leaderboard 702 shows a listing of users with their current scores. Scores may be total scores, per flight scores, or per time-period scores where a time-period can be daily, monthly, or some other time-period. Scores may be adjusted with handicapping adjustments or other modifications which allow users to compare themselves against other users. Scores may include other factors such as total time flown, number of landings, number of maneuvers, or other information that helps to differentiate users. The leaderboard 702 may be ordered differently depending on what a user is most interested in. Notification button 704 can be used to turn on notifications to users. Notifications may include information such as which user is currently in the lead, specific placement of specific users, and other information about what has recently changed in the system data. Notifications could also include suggestions for further practice including reminders about dates, suggestions of maneuvers to practice, or information about a user or groupings of users.

Data display 706 shows how data has changed over time. The data may be presented about a specific user or a grouping of users. Group button 708 may allow a user to select different users to be presented as part of a group. Head-to-head button 710 allows users to compare themselves directly against other users. The system may be integrated with prize awarding systems where a prize may comprise a title or any other kind of award.

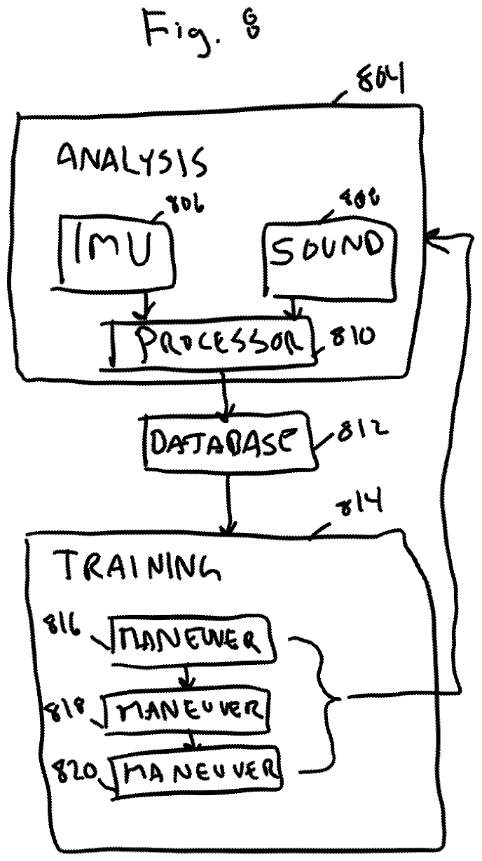

FIG. 8 is a diagram depicting a block diagram of another embodiment of a pilot training tool. The pilot training tool analyzes a pilot's flying through detection of flight characteristics and then builds a coaching plan based around improving those skills as needed. Analysis stage 804 measures certain physical characteristics of flight. An inertial measurement unit 806 detects uncoordinated flight, turns, high and low G conditions due to steep turns, top-of-climb changes, level flight, unstable approaches, left-turning tendencies, improper correction of P-factor accelerations, slow responses to turbulence, and other accelerations and motions that correspond to various flight conditions. A sound detection unit 808 detects airspeed including slow-flight and over-speed situations, engine management including tachometer speed and vibration, flap deployment configuration, and other sounds due to flight conditions. The processor 810 compares the configurations detected in inertial measurement unit 806 and sound detection unit 808 with a database of common configuration information to decode the inertial and sound data into the various flight regimes detected. Processor 810 builds up a database 812 of common flight issues seen by a particular pilot: do they keep the plane coordinated? Do they have stable approaches? Do they compensate for left turning tendencies? Are steep turns coordinated and steep enough? Are practice stalls always coordinated? Many other flight issues are possible based on every maneuver that can be detected with the sensors.

Training stage 814 uses the database 812 to build up a program of practice maneuvers including maneuver 816, maneuver 818, and maneuver 820. These maneuvers focus on issues spotted in the analysis stage. For example, a pilot that has problems with coordination during turns will have maneuver 816 include a practice turn. In another example, a pilot that does not present stable descents, will have maneuver 818 include a practice descent. More than one maneuver can be added that focus on any particular shortcoming. In this way, a syllabus of maneuvers can be built up. The syllabus may be presented to the pilot whenever they are in practice mode and can be scored independently from other flying.

The syllabus can be uploaded to a centralized database and compared with other pilots. The user interface of FIG. 7 may allow pilots to share their own syllabus with others. It can also classify pilots into different groups based on which maneuvers need the most work. Each pilot in the group may then be given the same syllabus of training maneuvers so that they are competing with each other to improve as a whole. Thus the group has a central core of practice to work on that is developed dynamically from the individual members of the group. In addition to dynamically created syllabi of training maneuvers, one pilot can create a syllabus for other pilots. This allows specific sets of maneuvers to be practiced by a group of pilots. Specific syllabi to focus on specific sets of skills can be built up and shared. Pilots are encouraged to improve through competition with each other.

The foregoing description of representative embodiments has been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated. One or more flow diagrams were used herein. The use of flow diagrams is not intended to be limiting with respect to the order in which operations are performed.

By way of example, the following are illustrative examples of the techniques presented.

An illustrative method of detecting a configuration of an aircraft is disclosed. A sound is recorded from an interior of an aircraft. A transform is calculated of the sound. The transform is compared with a calibration transform of a known configuration. A closeness parameter is determined based on the comparison. A detected configuration is indicated if the closeness parameter is above a threshold.

In alternative embodiments of the method, the transform of the sound is a Fourier Transform. In another embodiment of the method, the transform of the sound is a wavelet transform. In another embodiment of the method, the transform is a time-frequency transform. In another embodiment of the method, the transform of the sound is normalized before comparison with the first calibration transform. In alternative embodiments of the method, a factor used to normalize the transform is used to scale the detected configuration.

In alternative embodiments of the method, the first configuration is a first airspeed and the detected configuration is a detected airspeed. In another embodiment of the method, comparing the transform includes calculating a dot-product of the transform with the first calibration transform. In another embodiment of the method, a continuous moving average is used to smooth out the first closeness parameter.

Another illustrative method of detecting an airspeed of an aircraft is disclosed. A sound is recorded from an interior of an aircraft. A transform is calculated of the sound. The transform is compared with a first calibration transform of a known configuration. A first closeness parameter is determined based on the comparison. The transform is compared with a second calibration transform of a second configuration. A second closeness parameter is determined based on the comparison. A detected configuration is selected from between the first configuration and the second configuration based on the first closeness parameter and the second closeness parameter. The detected configuration is indicated to the user.

In alternative embodiments of the method, comparison of the transform includes identifying a difference in an analogous region between the first calibration transform and the second calibration transform and then comparing the analogous region of the transform with the analogous region of the first calibration transform and the second calibration transform.

In alternative embodiments of the method, selection of a detected configuration is based on a supervised machine learning.

What is claimed is:

1. A method of detecting a configuration of an aircraft, the method comprising:
recording a sound from an interior of an aircraft,
calculating a transform of the sound,
comparing the transform to a first calibration transform of a first configuration,
determining a first closeness parameter to the first calibration transform, and
indicating a detected configuration when the first closeness parameter is above a threshold.

2. The method of claim 1, wherein the transform of the sound is a Fourier Transform.

3. The method of claim 1, wherein the transform of the sound is a wavelet transform.

4. The method of claim 1, wherein the transform is a time-frequency transform.

5. The method of claim 1, wherein the transform of the sound is normalized before comparison with the first calibration transform.

6. The method of claim 5, wherein a factor used to normalize the transform is used to scale the detected configuration.

7. The method of claim 1, wherein the first configuration is a first airspeed and the detected configuration is a detected airspeed.

8. The method of claim 1, wherein comparing the transform includes calculating a dot-product of the transform with the first calibration transform.

9. The method of claim 1, wherein a continuous moving average is used to smooth out the first closeness parameter.

10. A method of detecting an airspeed, the method comprising:
recording a sound from an interior of an aircraft,
calculating a transform of the sound,
comparing the transform to a first calibration transform of a first airspeed,
determining a first closeness parameter to the first calibration transform,
comparing the transform to a second calibration transform of a second airspeed,
determining a second closeness parameter to the second calibration transform,
selecting a detected configuration from between the first airspeed and the second airspeed based on the first closeness parameter and the second closeness parameter, and
indicating the detected configuration.

11. The method of claim 10, wherein comparing the transform includes identifying a difference in an analogous region between the first calibration transform and the second calibration transform and then comparing the analogous region of the transform with the analogous region of the first calibration transform and the second calibration transform.

12. The method of claim 10, wherein selecting a detected configuration is based on a supervised machine learning.

13. A flight training device comprising:
a sound measurement unit;
a user interface; and
a processor operatively coupled to the sound measurement unit and the user interface, and configured to
record a sound from an interior of a cockpit with the sound measurement unit,
calculate a transform of the sound,
compare the transform to a first calibration transform of a first configuration,
determine a first closeness parameter to the first calibration transform, and
indicate, on the user interface, a detected configuration when the first closeness parameter is above a threshold.

14. The flight training device of claim 13, wherein the transform is a time-frequency transform.

15. The flight training device of claim 13, wherein the transform of the sound is normalized before comparison with the first calibration transform.

16. The flight training device of claim 15, wherein a factor used to normalize the transform is used to scale the detected configuration.

17. The flight training device of claim 13, wherein the first configuration is a first airspeed and the detected configuration is a detected airspeed.

18. The flight training device of claim 13, wherein comparing the transform includes calculating a dot-product of the transform with the first calibration transform.
